(19) United States
(12) Patent Application Publication
(10) Pub. No.: US 2025/0264623 A1
(43) Pub. Date: Aug. 21, 2025

(54) DEPTH UNCERTAINTY ESTIMATION USING INTERVAL-DOMAIN ANISOTROPIC VTI VELOCITY AND TRAVEL TIME DETECTABILITY

(71) Applicant: CHEVRON U.S.A. INC., San Ramon, CA (US)

(72) Inventors: Andrey Shabelansky, Bellaire, TX (US); Cory Hoelting, Houston, TX (US); Min Yang, Houston, TX (US); Sizhuang Deng, Houston, TX (US)

(21) Appl. No.: 18/443,971

(22) Filed: Feb. 16, 2024

(51) Int. Cl. G01V 1/30

(52) U.S. Cl. CPC G01V 1/305; G01V 2210/52; G01V 2210/6222; G01V 2210/626; G01V 2210/667

(57) ABSTRACT

Systems and methods are provided for subsurface characterization from seismic data. The system can receive seismic data comprising travel time values and offset values for a subsurface area of interest. An algorithm can perform a grid search across the seismic data using travel time detectability criteria in an interval time domain to determine high and low bounds of NMO velocity and a anisotropic anellipticity parameter. The system can generate depth functions based on the high and low bounds of the NMO velocity and the anisotropic anellipticity parameter. The depth functions can be used to determine the depth uncertainty. A graphical representation of the depth uncertainty can be generated. The system can characterize the subsurface area of interest based on the depth uncertainty.

### TECHNICAL FIELD

The present disclosure relates generally to hydrocarbon production, and in particular, some implementations may relate to characterizing subsurface features to estimate hydrocarbon production.

### DESCRIPTION OF RELATED ART

Subsurface depth uncertainty estimation plays an important role in the risk mitigation of hydrocarbon production and CO₂ storage. Depth uncertainty refers to any uncertainty in the target depths of subsurface features when detected using seismic data. Depth uncertainty, if ignored, can result in costly mistakes associated with well planning and drilling. Due to uncertainties of anisotropic seismic velocity, depth uncertainty can be estimated either during or after the estimation of the velocity of seismic data during a survey. Anisotropic seismic velocity refers to the velocity of seismic waves in a medium within the Earth. Current post-processing seismic depth uncertainty methods estimate uncertainties in normal moveout (“NMO”) velocity and anisotropic anellipticity parameter n. NMO velocity refers to the difference between the zero offset travel time and the travel time observed for a given source-receiver offset in a surface seismic survey. Anisotropic anellipticity parameter n refers to the elastic wave propagation in the subsurface medium. Uncertainties in NMO velocity and n are traditionally estimated in the effective time domain using travel time detectability criteria and a grid search scanning approach. Then, the uncertainty estimates of NMO velocity and n are propagated into a depth domain using an interval time domain transformation and the application of the Dix transform.

### BRIEF SUMMARY OF THE DISCLOSURE

According to various embodiments of the disclosed technology, a computer-implemented method for subsurface characterization from seismic data can comprise receiving, at a computer processor, seismic data comprising travel time values and offset values for a subsurface area of interest. This seismic data can include any seismic data comprising information on normal moveout (NMO) velocity and anisotropic anellipticity parameter n. An algorithm can perform a grid search across the seismic data using travel time detectability criteria in an interval time domain to determine NMO velocity and the anisotropic anellipticity parameter. This grid search can build off the computations of previous layers to provide a more accurate and efficient representation of depth uncertainty. The system can generate a depth function based on the NMO velocity and the anisotropic anellipticity parameter. The depth functions can be used to determine the depth uncertainty. The depth uncertainty can be calculated as the difference in depth functions. The computer processor can generate a graphical representation of the depth uncertainty based on corresponding depth and display depth uncertainty on a user interface based on the graphical representation. This display can comprise a heat map illustrating depth uncertainty at various locations in a subsurface area of interest. The system can characterize the subsurface area of interest based on the depth uncertainty.

In some embodiments, the travel time detectability criteria comprise a number of layers, a layer index parameter, and a ray parameter. The number of layers can be used to divide the seismic data for purposes of the grid search. The layer index parameter can indicate which layer is being searched.

In some embodiments, the ray parameter can be represented as

$$p = \frac{1}{{V}_{nmo}} \frac{h}{\sqrt{{( V {nmo , eff}_{} {t}_{0} )}^{2} + {h}^{2}}} \frac{{V}_{nmo}}{{V}_{nmo , eff}}$$

where Vₙₘₒ is the NMO velocity in an interval time domain, V_{nmo,eff} is NMO velocity in an effective time domain, t₀ is the vertical travel time, and h is an offset based on the travel time.

In some embodiments, the travel time can be represented as

$$t = {\sum }_{i}^{N} Δ {t}_{0}^{2} \frac{\frac{{{p}^{2} ( {V}_{nmo}^{i} )}^{2}}{{A}^{i} ( p )} + [ 1 - {{p}^{2} ( {V}_{hor}^{i} )}^{2} ]}{\sqrt{1 - {{p}^{2} ( {V}_{hor}^{i} )}^{2} {A}^{i} ( p )}}$$

In some embodiments, Aⁱ(p) can be represented as:

$${A}^{i} ( p ) = 1 - {p}^{2} [ {( {V}_{hor}^{i} )}^{2} - {( {V}_{nmo}^{i} )}^{2} ] .$$

In some embodiments, Vⁱₕₒᵣ can be represented as:

$${V}_{hor}^{i} = {V}_{nmo}^{i} \sqrt{1 + 2 {η}^{i}}$$

where ηⁱ is the anisotropic anellipticity parameter in a layer i.

In some embodiments, the depth uncertainty is determined based on a difference between a depth function associated with a high bound and a depth function associated with a low bound.

In some embodiments, the depth function associated with the high bound is based on a high bound NMO velocity, and the depth function associated with the low bound is based on a low bound NMO velocity.

According to various embodiments of the disclosed technology, a system for subsurface characterization from seismic data can comprise a processor; a display; and a memory encoded with instructions. The instructions, when executed by the processor, can cause the processor to receive seismic data indicating travel time and offset for a subsurface area of interest. This seismic data can include any seismic data comprising information on normal moveout (NMO) velocity and anisotropic anellipticity parameter n. An algorithm can perform a grid search across the NMO and horizontal velocities in an interval time domain using travel time detectability from seismic data to determine high and low bounds of NMO and horizontal velocities. The bounds of the anisotropic anellipticity parameter can be obtained from the bounds of the horizontal velocity. The travel time detectability criteria comprise a number of layers, a layer index parameter, and a ray parameter. The number of layers can be used to divide the seismic data for purposes of the grid search. The layer index parameter can indicate which layer is being searched. This grid search can build off the computations of previous layers to provide a more accurate and efficient representation of depth uncertainty. The system can generate a depth function based on the NMO velocity and the anisotropic anellipticity parameter. The depth functions can be used to determine the depth uncertainty. The depth uncertainty can be calculated as the difference in depth functions. The processor can generate a graphical representation of the depth uncertainty based on corresponding depth and display depth uncertainty on the display based on the graphical representation. This display can comprise a heat map illustrating depth uncertainty at various locations in a subsurface area of interest. The system can characterize the subsurface area of interest based on the depth uncertainty.

In some embodiments, the ray parameter can be represented as

$$p = \frac{1}{{V}_{nmo}} \frac{h}{\sqrt{{( V {nmo , eff}_{} {t}_{0} )}^{2} + {h}^{2}}} \frac{{V}_{nmo}}{{V}_{nmo , eff}}$$

where Vₙₘₒ is the NMO velocity in an interval time domain, V_{nmo,eff} is NMO velocity in an effective time domain, t₀ is the vertical travel time, and h is an offset between a source and a receiver.

In some embodiments, the travel time can be represented as:

$$t = {\sum }_{i}^{N} Δ {t}_{0}^{2} \frac{\frac{{{p}^{2} ( {V}_{nmo}^{i} )}^{2}}{{A}^{i} ( p )} + [ 1 - {{p}^{2} ( {V}_{hor}^{i} )}^{2} ]}{\sqrt{1 - {{p}^{2} ( {V}_{hor}^{i} )}^{2} {A}^{i} ( p )}}$$

where i is a layer index, p is the ray parameter, Vⁱₙₘₒ is the NMO velocity at a layer index, and Vⁱₕₒᵣ is horizontal velocity at the layer index.

In some embodiments, Aⁱ(p) can be represented as:

$${A}^{i} ( p ) = 1 - {p}^{2} [ {( {V}_{hor}^{i} )}^{2} - {( {V}_{nmo}^{i} )}^{2} ] .$$

In some embodiments, Vⁱₕₒᵣ can be represented as:

$${V}_{hor}^{i} = {V}_{nmo}^{i} \sqrt{1 + 2 {η}^{i}}$$

where ηⁱ is the anisotropic anellipticity parameter at the layer i.

In some embodiments, the depth uncertainty is determined based on a difference between a depth function associated with a high bound and a depth function associated with a low bound.

In some embodiments, the depth function associated with the high bound is based on a high bound NMO velocity, and the depth function associated with the low bound is based on a low bound NMO velocity.

According to various embodiments of the disclosed technology, a non-transitory machine-readable storage medium can be encoded with instructions, which, when executed by a processor, can cause the processor to receive seismic data comprising travel time values and offset values for a subsurface area of interest. This seismic data can include any seismic data comprising information on normal moveout (NMO) velocity and anisotropic anellipticity parameter n. An algorithm can perform a grid search across the NMO and horizontal velocities in an interval time domain using travel time detectability from seismic data to determine high and low bounds of NMO and horizontal velocities. The bounds of the anisotropic anellipticity parameter can be obtained from the bounds of the horizontal velocity. This grid search can build off the computations of previous layers to provide a more accurate and efficient representation of depth uncertainty. The system can generate depth functions based on the NMO velocity and the anisotropic anellipticity parameter. The depth functions can be used to determine the depth uncertainty by calculating a difference between a depth function associated with a high bound and a depth function associated with a low bound. The system can generate a graphical representation of the depth uncertainty based on corresponding depth and display depth uncertainty on a user interface based on the graphical representation. This display can comprise a heat map illustrating depth uncertainty at various locations in a subsurface area of interest. The system can characterize the subsurface area of interest based on the depth uncertainty.

In some embodiments, the travel time detectability criteria comprise a number of layers, and a layer index parameter. The number of layers can be used to divide the seismic data for purposes of the grid search. The layer index parameter can indicate which layer is being searched.

In some embodiments, the ray parameter can be represented as

$$p = \frac{1}{{V}_{nmo}} \frac{h}{\sqrt{{( V {nmo , eff}_{} {t}_{0} )}^{2} + {h}^{2}}} \frac{{V}_{nmo}}{{V}_{nmo , eff}}$$

where Vₙₘₒ is the NMO velocity in an interval time domain, Vₙₘₒ, eff is NMO velocity in an effective time domain, t₀ is the travel time, and h is an offset between seismic source and receiver.

In some embodiments, the travel time can be represented as

$$t = {\sum }_{i}^{N} Δ {t}_{0}^{2} \frac{\frac{{{p}^{2} ( {V}_{nmo}^{i} )}^{2}}{{A}^{i} ( p )} + [ 1 - {{p}^{2} ( {V}_{horr}^{i} )}^{2} ]}{\sqrt{1 - {{p}^{2} ( {V}_{hor}^{i} )}^{2} {A}^{i} ( p )}}$$

where i is the layer index, p is the ray parameter, Vⁱₙₘₒ is the NMO velocity at a layer index, and Vⁱₕₒᵣ is horizontal velocity at the layer index.

In some embodiments, Aⁱ(p) can be represented as:

$${A}^{i} ( p ) = 1 - {p}^{2} [ {( {V}_{hor}^{i} )}^{2} - {( {V}_{nmo}^{i} )}^{2} ]$$

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example system in accordance with the embodiments described herein.

FIGS. 2A-2C illustrate grid searching in accordance with the systems and methods described herein.

FIGS. 3A-3B illustrates example displays representing depth uncertainty estimation in a subsurface medium, in accordance with the systems and methods described herein.

FIG. 4 illustrates an example method in accordance with the embodiments described herein.

FIG. 5 is an example computing component that may be used to implement various features of embodiments described in the present disclosure.

The figures are not exhaustive and do not limit the present disclosure to the precise form disclosed.

### DETAILED DESCRIPTION

Traditional systems measure depth uncertainty using uncertainty estimates in NMO velocity and n that are computed in the effective time domain. These estimates can be converted into the interval time domain using the Dix transformation. The Dix transformation can be written as

$${v}_{n} = \sqrt{\frac{{V}_{n}^{2} {t}_{{0}_{n}} - {V}_{n - 1}^{2} {t}_{{0}_{n - 1}}}{{τ}_{n} - {τ}_{n - 1}}}$$

where Vₙ is NMO velocity in the effective time domain, vₙ is NMO velocity in the interval time domain, and t₀_{ₙ} is the vertical time. Subscripts n and n−1 refer to two consecutive time indices. However, the Dix transformation can be unstable in some circumstances as it requires a relatively small-time sampling and smoothing in both the effective domain and interval-time domain. Additionally, the Dix transformation can provide less accurate results, especially in the presence of complex geologic bodies such as salts and bodies with velocity inversion. Accordingly, using the Dix transformation can be less accurate and reliable in some instances, which can degrade the quality of the depth uncertainty estimations and reduce confidence levels.

Embodiments of the systems and methods disclosed herein can provide an improved depth uncertainty estimation algorithm directly in an interval time domain that employs the concept of travel time detectability criteria and grid search scanning, while computing travel time directly into the interval time domain. This new algorithm in the interval time domain produces depth uncertainty estimates with faster computation times and higher accuracy compared to algorithms in the effective time domain. Additionally, the systems and embodiments described herein are directed to an improved user interface for displaying and interacting with depth uncertainty estimations as provided above. As described above, traditional representations and displays may not be accurate due to instability of the Dix transformation. The systems and embodiments described herein disclose methods of displaying more accurate depth uncertainty information to the user, rather than using conventional user interface methods to generically display a rough estimate depth uncertainty. These systems recite a specific improvement over prior systems, resulting in an improved user interface for use in hydrocarbon production.

Depth uncertainty estimation in the interval time domain has multiple advantages over depth uncertainty estimation in the effective time domain. The first advantage is that depth uncertainty estimation in the interval time domain avoids any instability from the Dix transformation, which is required to transform calculations from an effective time domain into the interval time domain. Additionally, computations in the interval time domain have an increased accuracy because they incorporate layered velocities and ray tracing in one dimension. In contrast, computations in the effective time domain use an average velocity, which does not take into account the intricacies and detail available with layered velocities. The difference is increasingly apparent in media with complex environments that have salt bodies and/or over-pressured regions with velocity inversions. The drastic changes in velocities can muddle the average velocity, making the use of an average less accurate. Another advantage to algorithms in the interval time domain involves computational speed and efficiency. These algorithms compute results faster because of the increased travel-time step Δt₀ that is determined by the ray tracing requirements and not by Dix transformation stability.

These systems and embodiments improve the efficiency of hydrocarbon production by providing a more accurate representation of depth uncertainty in a subsurface area of interest. This improved display allows for the presentation and consumption of information in a unique and necessary manner that enables personnel to immediately have the information they need accurately and quickly identify desired or target hydrocarbon deposits. This display also assists in characterizing subsurface features in the area of interest, providing for quick selection of target hydrocarbon deposits or other target subsurface features. The speed and ease of using this display greatly reduces the time it takes to analyze seismic data, which is already a lengthy process. Rather than providing a rough estimate of depth uncertainty, this display greatly improves accuracy of analyzing seismic data and provides personnel with immediate information on important subsurface features.

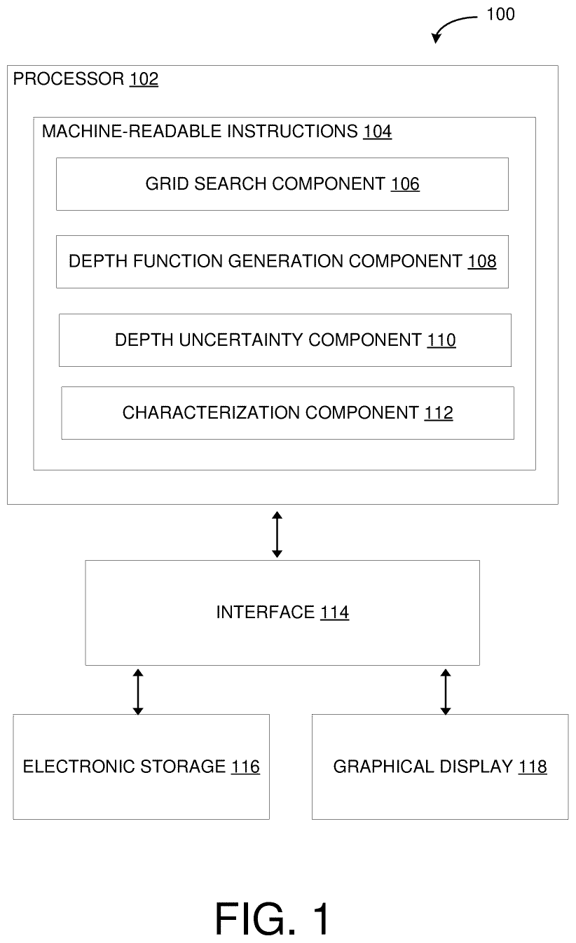

FIG. 1 illustrates an example system 100 incorporating the systems and methods described above. The electronic storage 116 may be configured to include an electronic storage medium that electronically stores information. The electronic storage 116 may store software algorithms, information determined by the processor 102, information received remotely, and/or other information that enables the system 100 to function properly. For example, electronic storage 116 may store information relating to seismic data, and/or other information. This information can include NMO and horizontal velocities in an interval time domain. The bounds of the anisotropic anellipticity parameter can be obtained from the bounds of the horizontal velocity. The electronic storage media of electronic storage 116 may be provided integrally (i.e., substantially non-removable) with one or more components of the system 100 and/or as removable storage that is connectable to one or more components of the system 100 via, for example, a port (e.g., a USB port, a Firewire port, etc.) or a drive (e.g., a disk drive, etc.). The electronic storage 116 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. Electronic storage 116 may be a separate component within system 100, or electronic storage 116 may be provided integrally with one or more other components of system 100 (e.g., processor 102). Although electronic storage 116 is shown in FIG. 1 as a single entity, this is for illustrative purposes only. In some implementations, electronic storage 116 may comprise a plurality of storage units. These storage units may be physically located within the same device, or electronic storage 116 may represent storage functionality of a plurality of devices operating in coordination.

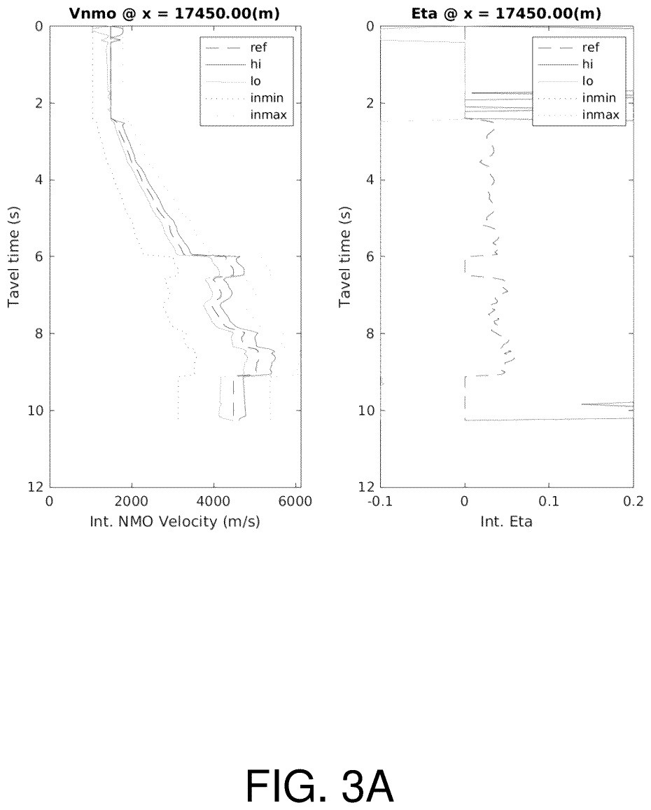

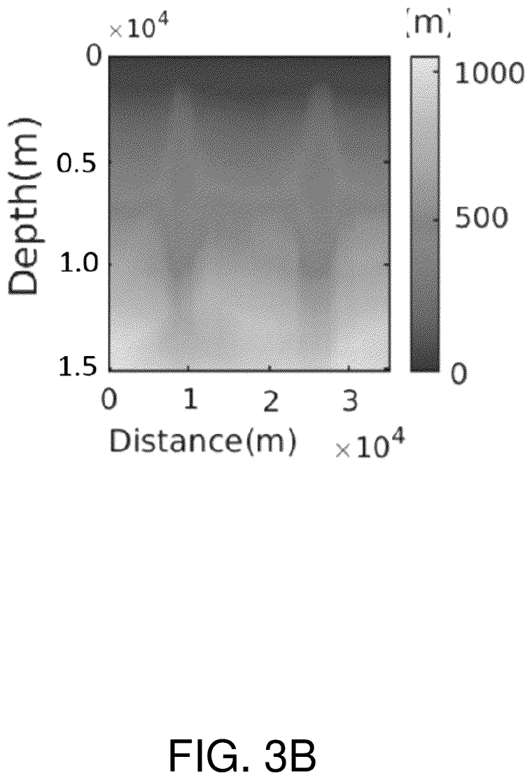

Graphical display 118 may refer to an electronic device that provides visual presentation of information. Graphical display 118 may include a color display and/or a non-color display. Graphical display 118 may be configured to visually present information. Graphical display 118 may present information using/within one or more graphical user interfaces. For example, graphical display 118 may present information relating to seismic data, seismic picks, and/or other information. Graphical display 118 may present information including, but not limited to, graphical representations of depth uncertainty as described below in FIG. 3.

Processor 102 may be configured to provide information processing capabilities in the system 100. As such, processor 102 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. Processor 102 may be configured to execute one or more machine-readable instructions 104 to facilitate seismic event picking. Machine-readable instructions 104 may include one or more computer program components. Machine-readable instructions 104 may include a grid search component 106, a depth function generation component 108, a depth uncertainty component 110, a characterization component 112, and/or other computer program components.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 102 and/or system 100 to perform the operation.

While computer program components are described herein as being implemented via processor 102 through machine-readable instructions 104, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 104, grid search component 106 may be configured to receive seismic data comprising anisotropic velocity, travel time values and offset values for a subsurface area of interest and perform a grid search across the NMO and horizontal velocities in an interval time domain using travel time detectability from seismic data to determine high and low bounds of NMO and horizontal velocities. The bounds of the anisotropic anellipticity parameter can be obtained from the bounds of the horizontal velocity.

Based on the seismic data, the system can receive information on 3D input velocity time integrals (“VTI”), referred to by reference vertical velocity V_{ref}(x,y,z). Seismic data can also indicate Thomsen parameter δ_{ref}(x,y,z), which captures the relationship between NMO velocity and the zero-offset average velocity as recorded by check shots in seismic data. Finally, as described above, from seismic data the system can determine anellipticity parameter η_{ref}(x,y,z). The system can convert these parameters into the interval time domain, as V_{ref}(x,y,t), δ_{ref}(x,y,t), and η_{ref}(x,y,t). The conversion can comprise a linear conversion from depth to time with V_{ref}(x,y,z). The equations described below illustrate one-dimensional time-dependent properties by way of example. These equations can incorporate all x, y, and t dimensions. Travel time in vertical transverse isotropy (VTI) media in the interval time domain can be calculated as:

$${t}^{j} = {{\sum }^{j}}_{i} Δ {t}_{0}^{2} \frac{\frac{{{p}^{2} ( {V}_{nmo}^{i} )}^{2}}{{A}^{i} ( p )} + [ 1 - {{p}^{2} ( {V}_{hor}^{i} )}^{2} ]}{\sqrt{1 - {{p}^{2} ( {V}_{hor}^{i} )}^{2} {A}^{i} ( p )}}$$

$$with$$

$${V}_{nmo}^{i} = {V}_{ref}^{i} \sqrt{1 + 2 {δ}^{i}}$$

$${V}_{hor}^{i} = {V}_{nmo}^{i} \sqrt{1 + 2 {η}^{i}}$$

$$p = \frac{1}{{V}_{nmo}^{i}} \frac{h}{\sqrt{{{V}^{i} {nmo , eff}_{} t )}^{2} + {h}^{2}}} \frac{{V}_{nmo}^{i}}{{V}_{n mo , eff}^{i}}$$

$${A}^{i} ( p ) = 1 - {p}^{2} [ {( {V}_{hor}^{i} )}^{2} - {( {V}_{nmo}^{i} )}^{2} ]$$

where Δtⁱ₀ is the vertical travel time of layer i, j is the index of the last layer (i.e., interval), p is the ray parameter, h is the offset between the source and receiver for the seismic survey, and Vⁱₙₘₒ and Vⁱ_{nmo,eff} are the NMO velocities (of layer i) in the interval and effective time domains, respectively.

The seismic data can be propagated into a graphical representation of Vₙₘₒ and η in the interval time domain. The resulting grid for a grid search can be bounded by V^{j}ₙₘₒ−ΔV^{j}ₙₘₒ: V^{j}ₙₘₒ+ΔV^{j}ₙₘₒ horizontally and ηⁱ−Δη^{j}: η^{j}+Δη^{j} vertically. For layer-stripping for the grid search, travel time can be written as:

$${t}^{j} = Δ {t}_{0}^{j} \frac{\frac{{{p}^{2} ( {V}_{nmo}^{j} )}^{2}}{{A}^{j} ( p )} + [ 1 - {{p}^{2} ( {V}_{hor}^{j} )}^{2} ]}{\sqrt{1 - {{p}^{2} ( {V}_{hor}^{j} )}^{2} {A}^{j} ( p )}} + {\sum }_{i = 1}^{j - 1} Δ {t}_{0}^{i} \frac{\frac{{{p}^{2} ( {V}_{nmo}^{i} )}^{2}}{{A}^{i} ( p )} + [ 1 - {{p}^{2} ( {V}_{hor}^{i} )}^{2} ]}{\sqrt{1 - {{p}^{2} ( {V}_{hor}^{i} )}^{2} {A}^{i} ( p )}}$$

The system can introduce uncertainty in the travel time of layer j only, Δt^{j} (i.e., travel time detectability criterion), and propagate this uncertainty into the uncertainties of the NMO and horizontal velocities as:

$${t}^{j} = Δ {t}_{0}^{j} \frac{\frac{{{p}^{2} ( {V}_{nmo , high}^{j} )}^{2}}{{A}_{high}^{j} ( p )} + [ 1 - {{p}^{2} ( {V}_{hor , low}^{j} )}^{2} ]}{\sqrt{1 - {{p}^{2} ( {V}_{hor , low}^{j} )}^{2} {A}_{high}^{j} ( p )}} + {\sum }_{i = 1}^{j - 1} Δ {t}_{0}^{i} \frac{\frac{{{p}^{2} ( {V}_{nmo , high}^{i} )}^{2}}{{A}_{high}^{i} ( p )} + [ 1 - {{p}^{2} ( {V}_{hor , low}^{i} )}^{2} ]}{\sqrt{1 - {{p}^{2} ( {V}_{hor , low}^{i} )}^{2} {A}_{high}^{i} ( p )}}$$

where j is the index of the layer where the grid search is applied, V^{j}_{nmo,high} and V^{j}_{hor,low} are the estimates of the high NMO and low horizontal velocities, and

$${A}_{high}^{i} ( p ) = 1 - {p}^{2} [ {( {V}_{hor , low}^{i} )}^{2} - {( {V}_{nmo , high}^{i} )}^{2} ]$$

The 2D grid is predefined between V^{j}ₙₘₒ and V^{j}ₙₘₒ+ΔV^{j}ₙₘₒ and between V^{j}ₕₒᵣ−ΔV^{j}ₕₒᵣ and V^{j}ₕₒᵣ, where

$$Δ {V}_{hor}^{j} = {V}_{nmo}^{j} \sqrt{1 + 2 {Δη}^{j}}$$

The low NMO (V^{j}_{nmo,low}) and high horizontal velocities (V^{j}_{hor,high} (or η^{j}_{high} that is obtained as

$${η}_{high}^{j} = {η}_{ref}^{j} + \frac{1}{2} Δ {η}^{j} ) )$$

can be calculated by replacing

$$\frac{1}{2} Δ {t}^{j}$$

with

$$- \frac{1}{2} Δ {t}^{j}$$

in the equations above and replacing, V^{j}_{nmo,high} and V^{j}_{hor,low} (or η^{j}_{low} that is obtained as

$${n}_{low}^{j} = {η}_{ref}^{j} - \frac{1}{2} Δ {η}^{j} ) )$$

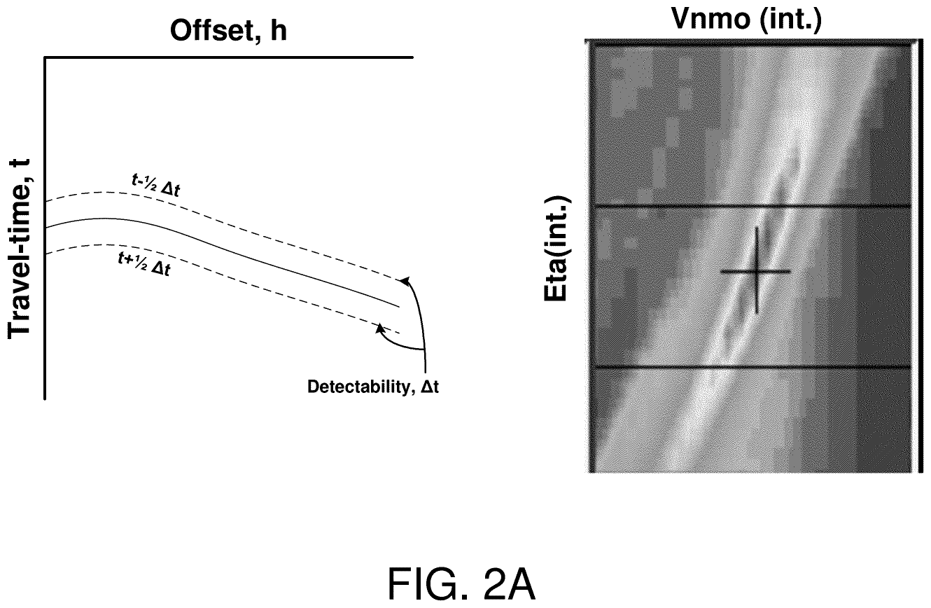

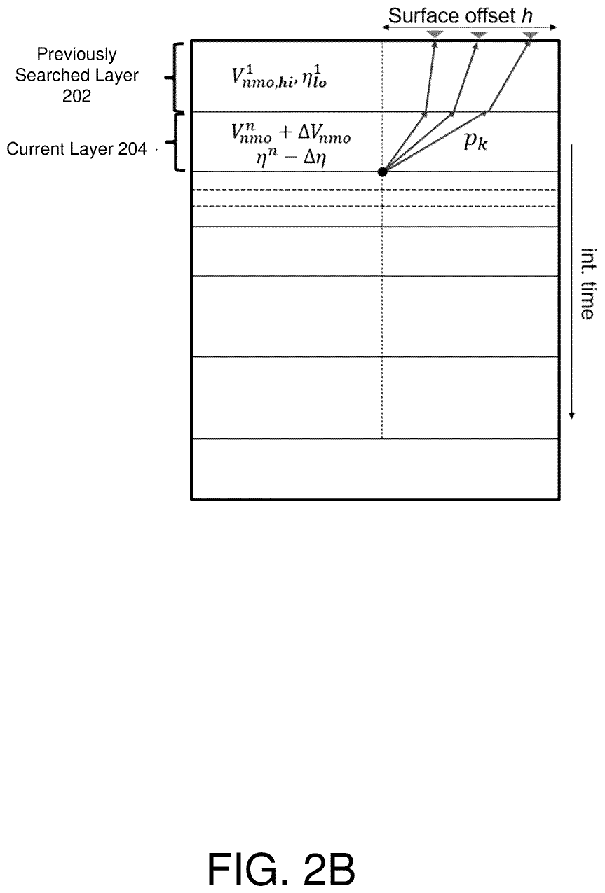

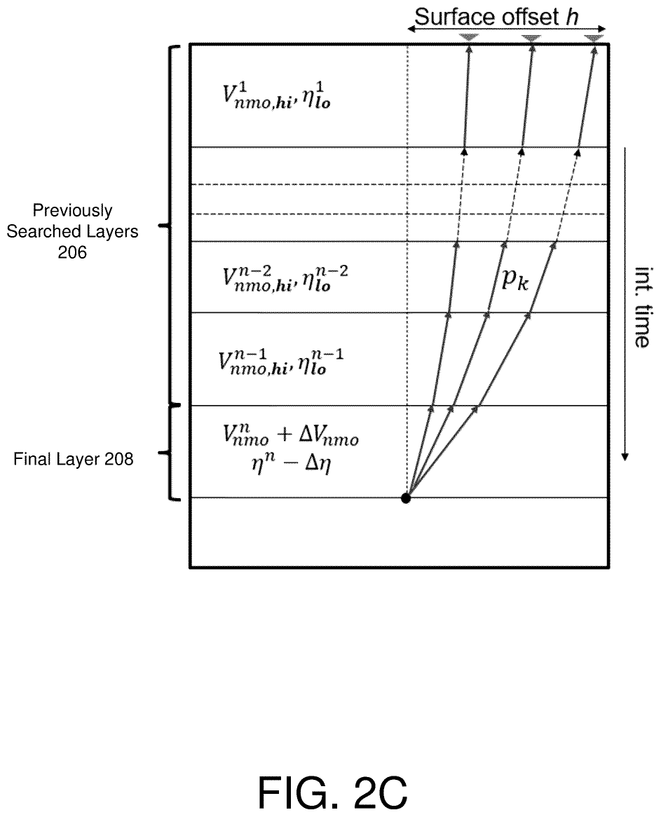

with V^{j}_{nmo,low} and V^{j}_{hor,high} respectively. It should be noted that Δt^{j} is related to the spatial and temporal resolution of the seismic data, and thus affects the data quality. This layer stripping approach to the grid search is illustrated further below in FIG. 2.

Depth function generation component 108 can generate a depth function after the grid search is completed. A depth function can be generated by propagating the depth uncertainty in Vₙₘₒ into functions of V_{ref} and δ_{ref}. The following empirical relationships can be applied to the above grid search results:

$${δ}_{high} ( x , y , t ) = \frac{1}{2} {η}_{high} ( x , y , t ) \\ {δ}_{low} ( x , y , t ) = \frac{1}{4} {η}_{low} ( x , y , t ) \\ {V}_{high} ( x , y , t ) = \frac{{v}_{n mo , high} ( x , y , t )}{\sqrt{1 + 2 {δ}_{low} ( x , y , t )}} \\ {V}_{low} ( x , y , t ) = \frac{{v}_{n mo , low} ( x , y , t )}{\sqrt{1 + 2 {δ}_{high} ( x , y , t )}}$$

given constraints

$${δ}_{low} ( x , y , t ) < {δ}_{ref} ( x , y , t ) < {δ}_{high} ( x , y , t ) - \frac{1}{2} < {δ}_{low} ( x , y , t )$$

The depth functions can be calculated as:

z_{ref}(x,y,t)=∫₀^{t}V_{ref}(x,y,t₀)dt₀

z_{high}(x,y,t)=∫₀^{t}V_{high}(x,y,t₀)dt₀

z_{low}(x,y,t)=∫₀^{t}V_{low}(x,y,t₀)dt₀

Based on the depth functions, depth uncertainty component 110 can define depth uncertainty as:

$$Δ z ( x , y , {z}_{r e f} ) = {z}_{h i g h} ( x , y , {z}_{r e f} ) - {z}_{l o w} ( x , y , {z}_{r e f} )$$

Here, z_{high}(x, y, z_{ref}) and z_{low}(x, y, z_{ref}) can be obtained from z_{high}(x, y, t) and z_{low}(x, y, t) respectively by linearly converting the functions from time to reference depth.

Characterization component 112 can characterize the subsurface area of interest based on the depth uncertainty. Depth uncertainty estimation is important in risk assessments for hydrocarbon exploration because it helps with economic evaluation of a potential prospect, guides well planning and drilling, and leads to optimal business decisions.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 102 may be configured to execute one or more additional computer program components that may perform some or all of the functionality attributed to one or more of computer program components described herein.

FIG. 2A illustrates an example grid search as described above. As described above, data collected from a seismic survey illustrates travel time moveout and detectability Δt corresponding to travel time uncertainty (FIG. 2A on the left side). This data is propagated into a graphical representation of Vₙₘₒ and n in the interval time domain (shown in FIG. 2A on the right side). An input grid for a grid search at each layer in FIG. 2A on the right side illustrates V^{j}ₙₘₒ on the horizontal axis and η^{j} on the vertical axis. The high and low bounds of Vₙₘₒ and n in the interval time domain at each layer are delineated with the magnitudes that correspond to the red colors in the input grid. As illustrated in FIGS. 2B and 2C, the grid search algorithm is applied layer by layer and uses the estimates from the previous layers. As illustrated in FIG. 2B, previously searched or first searched layer 202 can apply the calculations described above to determine V^{j}_{nmo,high} and η^{j}_{low}. As described above, current layer 204 can be searched based off of V^{j}_{nmo,high} and η^{j}_{low}. The estimates of the high and low bounds of the previous layers provide input for the layer where the grid search is performed and thus improve total computational time of the depth uncertainty estimation. FIG. 2C illustrates the continuation of this grid search until final layer 208 is finally searched by demonstrating how the high and low bounds are computed using the layer stripping approach.

FIG. 3A illustrates an example graphical estimation of the high and low bounds of the Vₙₘₒ and n as a function of vertical two-way time. The curves in FIG. 3A marked with “ref” correspond the input models. The curves in FIG. 3A marked with “inmin” and “inmax” correspond to the input grid in FIG. 2A. The curves in FIG. 3A marked with “hi” and “lo” correspond the high and low bounds that are obtained by the grid search algorithm. As illustrated in FIG. 3A, Vₙₘₒ and η can each be separately graphed against the vertical two-way time. The high and low bounds can be separately referenced by different plot lines. FIG. 3B illustrates a graphical representation of the depth uncertainty once determined from the depth functions. In the example of FIG. 3, uncertainty tends to increase as the depth increases. However, there are two spots of lower uncertainty illustrated. These sections can indicate subsurface spatial variability of the depth uncertainty estimates where low and high uncertainties correspond to geologic descriptions that can be used in risk assessments for hydrocarbon exploration. This graphical representation provides more accurate depth uncertainty information to the user, rather than using conventional user interface methods to generically display a rough estimate depth uncertainty. As described above, this graphical representation improves the efficiency of hydrocarbon production by providing a more accurate representation of depth uncertainty in a subsurface area of interest. This improved display allows for the presentation and consumption of information in a unique and necessary manner that enables personnel to immediately have the information they need accurately and quickly identify desired or target hydrocarbon deposits.

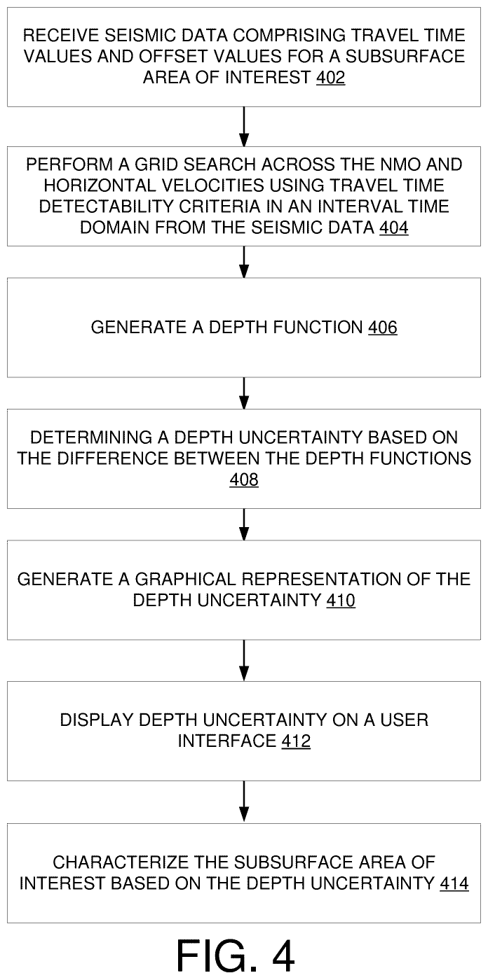

FIG. 4 illustrates an example method in accordance with the embodiments described above. At block 402, the system can receive seismic data comprising travel time values and offset values for a subsurface area of interest. In some embodiments, this data can comprise three-dimensional reference models of V_{ref}, δ and η in a depth domain. The system can convert Thomsen parameters to n if needed.

At block 404, the system can perform a grid search across the NMO and horizontal velocities in an interval time domain using travel time detectability from the seismic data to determine high and low bounds of NMO and horizontal velocities. The bounds of the anisotropic anellipticity parameter can be obtained from the bounds of the horizontal velocity. In some embodiments, the travel time detectability criteria comprise a number of layers, a layer index parameter, and a ray parameter. The ray parameter can be computed as

$$p = \frac{1}{{V}_{n m o}} \frac{h}{\sqrt{{{〚 ( V 〛}_{nmo , eff} {t}_{0} )}^{2} + {h}^{2}}} \frac{{V}_{n m o}}{{V}_{n m o , e f f}}$$

The system can convert the reference models into an interval time domain as Vₙₘₒ and n. The grid search can be used to compute V_{nmo,high}, V_{nmo,low}, η_{high} and η_{low} to empirically model V_{high}. In some embodiments, travel time can be illustrated as

$$t = {\sum }_{i}^{N} Δ {t}_{0}^{2} \frac{\frac{{{p}^{2} ( {V}_{n m o}^{i} )}^{2}}{{A}^{i} ( p )} + [ 1 - {{p}^{2} ( {V}_{hor}^{i} )}^{2} ]}{\sqrt{1 - {{p}^{2} ( {V}_{hor}^{i} )}^{2} {A}^{i} ( p )}}$$

At block 406, the system can generate a depth function based on the NMO velocity and the anisotropic anellipticity parameter. As described above, the algorithm can empirically model V_{high}, V_{low}, δ_{high} and δ_{low}. Using these models, the system can generate depth functions z_{ref}, z_{high} and z_{low}.

At block 408, the system can determine a depth uncertainty based on the difference between the depth functions. In some embodiments, this depth uncertainty can be determined based on a difference between a depth function associated with a high bound and a depth function associated with a low bound. The system can convert z_{high}(x,y,t) to z_{high}(x,y,z_{ref}) and z_{low}(x,y,t) to z_{low}(x,y,z_{ref}). In other words, the depth uncertainty can be:

$$Δ z ( x , y , {z}_{r e f} ) = {z}_{h i g h} ( x , y , {z}_{r e f} ) - {z}_{l o w} ( x , y , {z}_{r e f} )$$

At block 410, the system can generate a graphical representation of the depth uncertainty based on corresponding depth and at block 412, display depth uncertainty on a user interface based on the graphical representation. As described above in FIG. 3, this graphical representation may comprise a heat map illustrating depth uncertainty at various locations in the subsurface area of interest. The graphical representation may be color coded based on the levels of depth uncertainty. Any graphical representation or display can be used to illustrate the functions described above.

At block 414, the system can characterize the subsurface area of interest based on the depth uncertainty. As described above, the display assists in characterizing subsurface features in the area of interest, providing for quick selection of target hydrocarbon deposits or other target subsurface features. The speed and ease of using this display greatly reduces the time it takes to analyze seismic data, which is already a lengthy process. Rather than providing a rough estimate of depth uncertainty, this display greatly improves accuracy of analyzing seismic data and provides personnel with immediate information on important subsurface features.

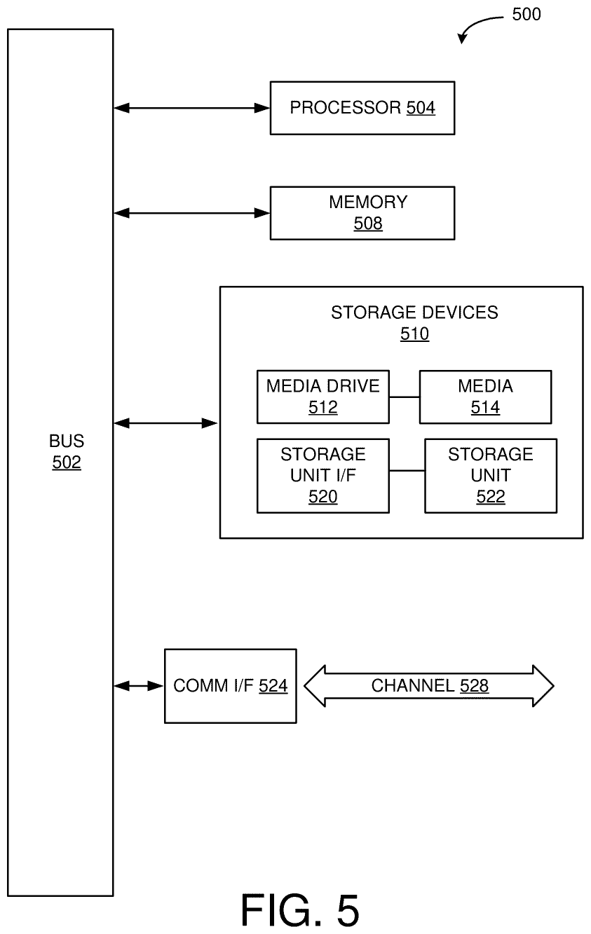

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionalities can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for subsurface characterization from seismic data, the method comprising:
receiving, at a computer processor, seismic data comprising travel time values and offset values for a subsurface area of interest;
performing a grid search across the seismic data using travel time detectability criteria in an interval time domain to determine a high bound and a low bound of NMO velocity and an anisotropic anellipticity parameter;
generating depth functions based on the high bound and the low bound of the NMO velocity and the anisotropic anellipticity parameter;
determining a depth uncertainty based on a difference between the depth functions;
generating a graphical representation of the depth uncertainty based on corresponding depth;
displaying depth uncertainty on a user interface based on the graphical representation; and
characterizing the subsurface area of interest based on the depth uncertainty.

2. The computer-implemented method of claim 1, wherein the travel time detectability criteria comprise a number of layers, a layer index parameter, and a ray parameter.

3. The computer-implemented method of claim 2, wherein the ray parameter is determined as
$$p = \frac{1}{{V}_{n m o}} \frac{h}{\sqrt{{{〚 ( V 〛}_{nmo , eff} {t}_{0} )}^{2} + {h}^{2}}} \frac{{V}_{n m o}}{{V}_{n m o , e f f}}$$
Where Vₙₘₒ is the NMO velocity, V_{nmo,eff} is NMO velocity in an effective time domain, t₀ is vertical travel time, and h is an offset based on the travel time values.

4. The computer-implemented method of claim 2, wherein the travel time values can be represented as
$$t = {\sum }_{i}^{N} Δ {t}_{0}^{2} \frac{\frac{{{p}^{2} ( {V}_{n m o}^{i} )}^{2}}{{A}^{i} ( p )} + [ 1 - {{p}^{2} ( {V}_{hor}^{i} )}^{2} ]}{\sqrt{1 - {{p}^{2} ( {V}_{hor}^{i} )}^{2} {A}^{i} ( p )}}$$
where i is a layer index, p is the ray parameter, Vⁱₙₘₒ is the NMO velocity at a layer index, and Vⁱₕₒᵣ is horizontal velocity at the layer index.

5. The computer-implemented method of claim 4, wherein Aⁱ(p) can be represented as
$${A}^{i} ( p ) = 1 - {p}^{2} [ {( {V}_{hor}^{i} )}^{2} - {( {V}_{n m o}^{i} )}^{2} ] .$$

6. The computer-implemented method of claim 4, wherein Vⁱₕₒᵣ can be represented as
$${V}_{h o r}^{i} = {V}_{m o}^{i} \sqrt{1 + 2 {η}^{i}}$$
where ηⁱ is the anisotropic anellipticity parameter.

7. The computer-implemented method of claim 1, wherein the depth uncertainty is determined based on a difference between a depth function associated with a high bound and a depth function associated with a low bound.

8. The computer-implemented method of claim 7, wherein the depth function associated with the high bound is based on a high bound NMO velocity, and the depth function associated with the low bound is based on a low bound NMO velocity.

9. A system for subsurface characterization from seismic data comprising:
a processor;
a display; and
a memory encoded with instructions, which when executed by the processor, cause the processor to:
receive, at a computer processor, seismic data indicating travel times and offsets for a subsurface area of interest;
perform a grid search across the seismic data based on a number of layers, a layer index parameter, and a ray parameter in an interval time domain to determine a high bound and a low bound of NMO velocity and an anisotropic anellipticity parameter;
based on the high bound and the low bound of the NMO velocity and the anisotropic anellipticity parameter, compute depth functions for the subsurface area of interest;
determine depth uncertainty based on a difference between the depth functions;
display depth uncertainty on a user interface based on a graphical representation of the depth uncertainty based on corresponding depth; and
characterize the subsurface area of interest based on the depth uncertainty.

10. The system of claim 9, wherein the ray parameter is determined as
$$p = \frac{1}{{V}_{n m o}} \frac{h}{\sqrt{{{〚 ( V 〛}_{nmo , eff} {t}_{0} )}^{2} + {h}^{2}}} \frac{{V}_{n m o}}{{V}_{nmo , f}}$$
where Vₙₘₒ is the NMO velocity, V_{nmo,eff} is NMO velocity in an effective time domain, t₀ is vertical travel time, and h is an offset based on the travel time values.

11. The system of claim 10, wherein the travel time values can be represented as
$$t = {\sum }_{i}^{N} Δ {t}_{0}^{2} \frac{\frac{{{p}^{2} ( {V}_{n m o}^{i} )}^{2}}{{A}^{i} ( p )} + [ 1 - {{p}^{2} ( {V}_{hr}^{i} )}^{2} ]}{\sqrt{1 - {{p}^{2} ( {V}_{hor} )}^{2} {A}^{i} ( p )}}$$
where i is a layer index, p is the ray parameter, Vⁱₙₘₒ is the NMO velocity at a layer index, and Vⁱₕₒᵣ is horizontal velocity at the layer index.

12. The system of claim 11, wherein Aⁱ(p) can be represented as
$${A}^{i} ( p ) = 1 - {p}^{2} [ {( {V}_{h o r}^{i} )}^{2} - {( {V}_{n m o}^{i} )}^{2} ] .$$

13. The system of claim 11, wherein Vⁱₕₒᵣ can be represented as
$${V}_{h o r}^{i} = {V}_{n m o}^{i} \sqrt{1 + 2 {η}^{i}}$$
where ηⁱ is the anisotropic anellipticity parameter.

14. The system of claim 9, wherein the depth uncertainty is determined based on a difference between a depth function associated with a high bound and a depth function associated with a low bound.

15. The system of claim 14, wherein the depth function associated with the high bound is based on a high bound NMO velocity, and the depth function associated with the low bound is based on a low bound NMO velocity.

16. A non-transitory machine-readable storage medium encoded with instructions, which, when executed by a processor, cause the processor to:
receive, at a computer processor, seismic data indicating travel time and offset for a subsurface area of interest;
perform a grid search across the seismic data based on travel time detectability criteria in an interval time domain to determine a high bound and a low bound of NMO velocity and an anisotropic anellipticity parameter;
based on the NMO velocity and the anisotropic anellipticity parameter, compute depth functions for the subsurface area of interest;
determine depth uncertainty based on a difference between a depth function associated with a high bound and a depth function associated with a low bound;
display depth uncertainty on a user interface based on a graphical representation of the depth uncertainty based on corresponding depth; and
characterize the subsurface area of interest based on the depth uncertainty.

17. The non-transitory machine-readable storage medium of claim 16, wherein the travel time detectability criteria comprise a number of layers, a layer index parameter, and a ray parameter.

18. The non-transitory machine-readable storage medium of claim 17, wherein the ray parameter is determined as
$$p = \frac{1}{{V}_{n m o}} \frac{h}{\sqrt{{{〚 ( V 〛}_{nmo , eff} {t}_{0} )}^{2} + {h}^{2}}} \frac{{V}_{n m o}}{{V}_{n m o , e f f}}$$
where Vₙₘₒ is the NMO velocity, V_{nmo,eff} is NMO velocity in an effective time domain, t₀ is a vertical travel time, and h is an offset based on the travel time.

19. The non-transitory machine-readable storage medium of claim 17, wherein the travel time can be represented as
$$t = {\sum }_{i}^{N} Δ {t}_{0}^{2} \frac{\frac{{{p}^{2} ( {V}_{n m o}^{i} )}^{2}}{{A}^{i} ( p )} + [ 1 - {{p}^{2} ( {V}_{ho}^{i} )}^{2} ]}{\sqrt{1 - {{p}^{2} ( {V}_{hor}^{i} )}^{2} {A}^{i} ( p )}}$$
where i is a layer index, p is the ray parameter, Vⁱₙₘₒ is the NMO velocity at a layer index, and Vⁱₕₒᵣ is horizontal velocity at the layer index.

20. The non-transitory machine-readable storage medium of claim 19, wherein Aⁱ(p) can be represented as
$${A}^{i} ( p ) = 1 - {p}^{2} [ {( {V}_{h o r}^{i} )}^{2} - {( {V}_{n m o}^{i} )}^{2} ] .$$
